(19) United States
(12) Patent Application Publication
(10) Pub. No.: US 2016/0315562 A1
(43) Pub. Date: Oct. 27, 2016

(54) ENERGY HARVESTING SYSTEMS, APPARATUS, AND METHODS

(71) Applicant: Everywhere Energy Inc., Austin, TX (US)

(72) Inventors: Darla Hollander, Austin, TX (US); Melinda Haghighatian, Houston, TX (US); Rory Tatum, Austin, TX (US); Kristopher Williams, Seattle, WA (US); Lorena Winicki, Houston, TX (US); Katelyn Stewart, Irvine, CA (US)

(21) Appl. No.: 15/136,765

(22) Filed: Apr. 22, 2016

Related U.S. Application Data
(60) Provisional application No. 62/150,959, filed on Apr. 22, 2015.

(51) Int. Cl. H02N 1/08

(52) U.S. Cl. CPC H02N 1/08

(57) ABSTRACT

Energy harvesting apparatus, systems, and methods comprising a variable capacitor, a charge source, and an actuator. In some embodiments, the charge source places an initial charge on the capacitor. Meanwhile, the actuator is driven by a reciprocating (external) driver which varies the capacitance of the capacitor. The load is in communication with the capacitor such that, as its capacitance varies, it delivers power to the load. The load can be a battery which can be the source of the charge. Furthermore, the capacitor can further comprise a plurality of stacked capacitors. As to the conductive layers of the capacitor, one of them can further comprise a gel, grease, or oil. Note that the actuator can vary a thickness of the (pre-tensioned) dielectric layer and that the actuator can vary the area of the dielectric layer. Furthermore, a surface of the dielectric layer can be coated with a release agent.

### CROSS REFERENCE TO RELATED APPLICATIONS

This application claims priority to and is a non-provisional application of U.S. provisional patent application No. 62/150,959 titled Compression-Triggered Energy Harvesting Systems, Apparatus, and Methods, filed by Darla Johanna Hollander et al. on Apr. 22, 2015 the entirety of which is incorporated herein as if set forth in full.

### BACKGROUND

Often, a mobile device user will find themselves in an environment where power (and/or an electrical outlet, adapter, etc.) to charge a device is not available. For instance, when walking in some areas, a user can be within range of a cellular tower and hence able to place telephone calls as long as their cellular phone remains charge yet not have power available for that device. In other situations (for instance, third world and/or under-developed regions) power outages can occur unexpectedly for varying lengths of time. Of course, while the power is “out” even users with outlets available cannot re-charge their mobile devices.

And, as anyone who has ever used a cellular phone readily knows, cellular phone batteries are prone to discharge particularly with heavy use. For instance, when capturing video, acting as a WiFi hotspot, receiving (or transmitting) streamed data, etc., these batteries can discharge at a relatively rapid rate. Another factor to consider regarding mobile device power, is that when mobile devices attempt to communicate with distant transceivers (for instance, cellular towers in remote/rural locations), they tend to use relatively large amounts of power to overcome the distant “connection.” Of course, while its battery remains discharged, the mobile device lays dormant, unable to place/receive calls, play/record audio and/or video (and/or multi-media) files, send/transmit messages/e-mails, capture/display photos, handle scheduling/calendaring matters, record/display notes, play applications, and/or a large number of other functions of which these devices are otherwise capable.

As these batteries age, these problems become worse. For one matter, as some batteries age, their energy-storage capacity can diminish thereby making it all the more likely that the battery will become discharged at an inconvenient time. Furthermore, with such diminished capacity, these batteries require increasingly frequent re-charging thereby tying these devices to particular locations for the recharges and/or requiring the users to carry (in addition to the devices) a portable re-charger and/or external battery.

### SUMMARY

The following presents a simplified summary in order to provide an understanding of some aspects of the disclosed subject matter. This summary is not an extensive overview of the disclosed subject matter, and is not intended to identify key/critical elements or to delineate the scope of such subject matter. A purpose of the summary is to present some concepts in a simplified form as a prelude to the more detailed disclosure that is presented herein. The current disclosure provides systems, apparatus, methods, etc. for providing electrical power and, more particularly, for generating off-grid electrical power from readily available mechanical sources for powering mobile devices.

Embodiments provide systems, apparatus, and methods which allow users to “be their own battery.” Such embodiments provide self-energizing power solutions in that these solutions harvest energy/power from every day (or relatively frequent) user actions (for instance, walking, running, riding, dancing, driving, opening/closing objects, etc.) and use that energy/power (hereinafter “energy”) to power and/or recharge mobile (and/or other) devices and/or their batteries. Thus, some embodiments provide energy harvesting systems which, when installed on a door, 1) harvest energy associated with opening and closing the door, 2) power a mobile device and/or charge a battery with the harvested energy, 3) charge a battery, etc. Some embodiments provide wearable apparatus which, when worn, harvest energy from the wearer/user's actions to power a load. For instance, inserts for shoes which harvest energy as they are compressed/released by the gait of their wearers are provided. These shoe-inserts can be used to power mobile devices which their users hold, transport, etc. as well as other devices. Of course, shoes (and other objects) can be manufactured with energy harvesters incorporated therein. Energy harvesters (or chargers) of embodiments will be available from Everywhere Energy Inc. of Delaware with facilities in Austin, Tex.

Various embodiments provide apparatus comprising a variable capacitor, a charge source, an actuator, and a load. In the current embodiment, the charge source is in electrical communication with the variable capacitor and is configured to place an initial charge on the variable capacitor. Meanwhile, the actuator is operably coupled to the variable capacitor and is configured to be driven by a reciprocating driver and/or a driver which moves in a more or less back and forth manner. The driver can be external to the apparatus and (as the driver reciprocates) the actuator varies the configuration and/or capacitance of the variable capacitor. And, being operationally coupled with the actuator, it causes the actuator to move as it applies varying power to the same. Moreover, the load is in electrical communication with the variable capacitor such that, as the capacitance of the variable capacitor varies, the variable capacitor delivers power to the load.

In some embodiments, the load is a battery and the battery can be the source of the initial charge. Moreover, in various embodiments, the variable capacitor further comprises a plurality of stacked variable capacitors. The number and size of the various stacked capacitors can be selected to produce chargers of desired capacities. Note that the variable capacitor(s) can further comprise a dielectric formed from an insulating membrane that can be pre-tensioned or pre-stretched. As to the plates, or conductive layers of the variable capacitor, at least one of them can further comprise a gel. The variable capacitor of embodiments further comprises a dielectric layer. Moreover, the actuator of the current embodiment is operably coupled to the variable capacitor in such a manner that it varies a thickness and/or surface area of the dielectric layer. Furthermore, one or more surfaces of the dielectric layer can be coated with a release agent. Furthermore, a spring or other biasing agent can be mechanically coupled to adjacent layers to urge them apart.

Various embodiments provide systems comprising variable capacitors, initial charge sources, actuators, reciprocating drivers, and loads. In such embodiments, the reciprocating drivers are configured to drive the actuators such that (as the drivers reciprocate) the actuators vary the capacitances of the variable capacitors and the variable capacitors deliver power to the loads.

To the accomplishment of the foregoing and related ends, certain illustrative aspects are described herein in connection with the annexed figures. These aspects are indicative of various non-limiting ways in which the disclosed subject matter may be practiced, all of which are intended to be within the scope of the disclosed subject matter. Other novel and/or nonobvious features will become apparent from the following detailed disclosure when considered in conjunction with the figures and are also within the scope of the disclosure.

### BRIEF DESCRIPTION OF THE FIGURES

The detailed description is described with reference to the accompanying figures. In the figures, the left-most digit(s) of a reference number usually corresponds to the figure in which the reference number first appears. The use of the same reference numbers in different figures usually indicates similar or identical items.

FIG. 1 illustrates a system for harvesting and using energy.

FIG. 2 illustrates various energy harvesting devices.

FIG. 3 illustrates an energy harvesting device of embodiments.

FIG. 4 illustrates a cross-sectional view of the energy harvesting device of FIG. 3 as seen along line AA.

FIG. 5 illustrates a variable capacitor of an energy harvesting device in a pre-stretched state.

FIG. 6 illustrates a variable capacitor of an energy harvesting device in a stretched state.

FIG. 7 illustrates a block diagram of an energy harvesting device.

FIG. 8 illustrates another energy harvesting device.

FIG. 9 illustrates yet another energy harvesting device.

FIG. 10 illustrates a flowchart of a method in accordance with embodiments.

FIG. 11 is a graph illustrating the power verse time performance of an experimental variable capacitor of embodiments.

FIG. 12 illustrates a graph of the expected energy and actual energy generated by that experimental variable capacitor of FIG. 11.

FIG. 13 illustrates a schematic of am energy harvesting device of embodiments.

### DETAILED DESCRIPTION

This document discloses systems, apparatus, methods, etc. for providing electrical power and, more particularly, for generating off-grid electrical power from readily available mechanical sources for powering mobile devices.

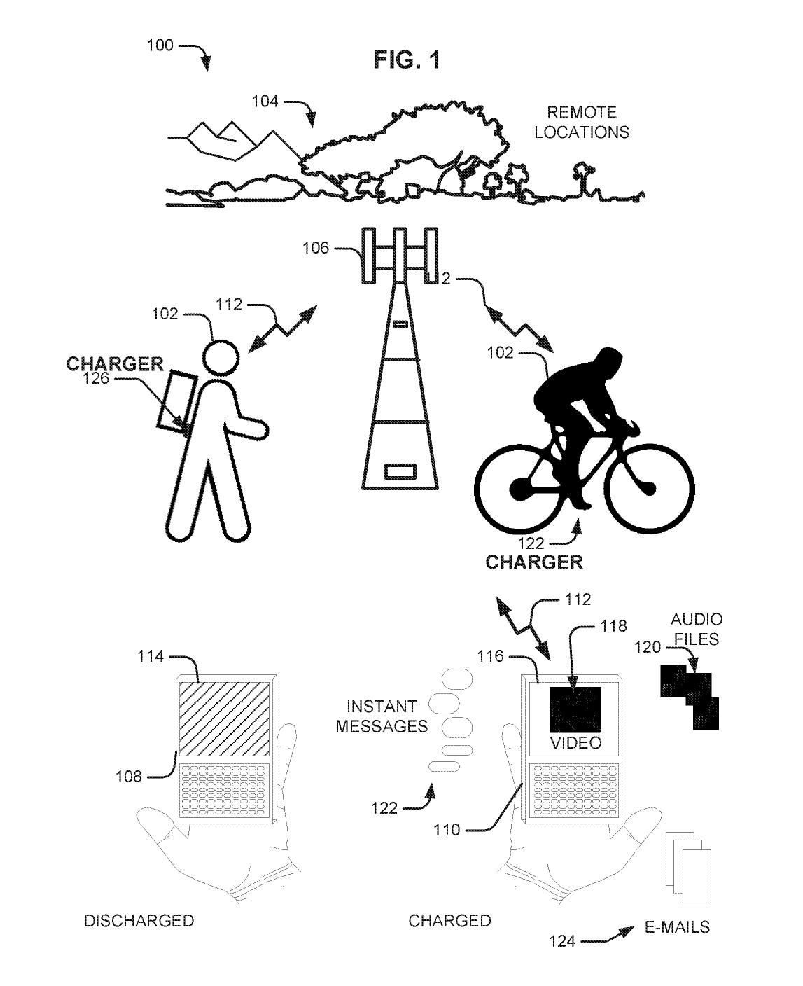

FIG. 1 illustrates a system for harvesting and using energy. Generally, FIG. 1 illustrates a system which uses the energy (and/or power) associated with common activities to charge electronic devices and/or their energy storage components (for instance, batteries). In many instances, these activities might be occurring in remote areas. These remote areas might lack re-charging infrastructure yet energy is still available to be harvested from these common activities occurring at these locations. For instance, joggers, hikers, bikers, campers, etc. often travel to (and/or through) scenic areas in which power outlets cannot be easily found. Yet, in accordance with embodiments, the activities that bring these users to these locations can be harvested for energy for their electronic devices.

With continuing reference to FIG. 1, the drawing illustrates a system 100, some of its users 102, a remote location 104, a cellular tower 106, a discharged device 108, a charged (or powered) device 110, near field, WiFi, telecommunications, cellular, etc. transmissions 112, a darkened display 114, a live display 116, video images 118, audio files 120, instant messages 122, email messages 124, chargers 126, batteries, etc. The users 102 can be any of a variety of users engaged in activities from which energy can be harvested. FIG. 1, for instance, illustrates two particular users 102 who happen to be bicycling and hiking. In the case of hikers, energy can be harvested from movement associated with their hiking by placing chargers between things that move (repeatedly) relative to one another while the user 102 is hiking. Thus, an energy harvesting device of embodiments could be placed (for instance) between the user's foot and the sole of that user's shoe, between the user's backpack and the body of the user. In the case of the bicycling user 102, a charging device could be placed between the pedal of their bike and the use's foot. Or, in accordance with embodiments, a charging device could be placed on/in the bicycle seat, bicycle tire, such that the user's actions, bodily movement, and/orshifting weight actuates the charging device. Of course, chargers of embodiments can be placed in/on a wide variety of mechanical devices.

Of course, outdoor enthusiasts are not the only ones who experience problems, inconveniences, outages, etc. associated with discharged mobile devices. For instance, business people who are “on the go” all day rarely have time to find an outlet, stop, and let their mobile devices charge. Emergency first-responders also find themselves (at times) too busy to stop and charge their devices lest more time-critical matters (for instance, saving the wounded) go unattended. Likewise, people “on call” may not have the luxury of waiting for their devices to charge before heading to an assignment.

FIG. 1 also illustrates a remote location at which power might/might not be available. The illustrated remote location could be (or include) a mountainous or forested region. Of course, it could be a prairie or other open space or even a region on/near the water such as a lake, bay, river, ocean, etc. Systems, devices, etc. of embodiments, however, can be used in locations other than remote locations 104. For instance, they can be used in urban and/or suburban settings as well as in buildings, boats, automobiles, vehicles, etc. Indeed, energy harvesting devices can be used under just about any circumstance in which the owner finds it inconvenient (or impracticable) to find an outlet/power (or even when an outlet is available).

Note that some of these locations might/might not be near a cellular (or wireless communications) tower 106, or antenna. Yet, the charged devices 110 can be used even if not in communication with a (tele)communication systems. Moreover, some charged devices can be configured to work with WiFi, GSM (Global System for Mobile Communications), CDMA (Code Division Multiple Access), and/or a wide variety of communication technologies ranging from at least near field communications to at least telecommunications. But, some of these devices could be configured such that they have no telecommunication abilities. That is, but for a need for being re-charged, such devices can be stand-alone devices such as MP3 players, GPS units, cameras, computers, etc.

With continuing reference to FIG. 1, it might now be helpful to compare a typical discharged device 108 with a typical charged device 110. While FIG. 1 illustrates these devices as being cellular telephones, many other devices are within the scope of the disclosure. That being said, in many scenarios, the discharged device 108 can be so completely discharged that practicably no power is available to its components and it is therefore colloquially said to be “dead.” Indeed, if the discharged device 108 does not contain some nonvolatile memory, then any data that might have been stored on it is at risk of irretrievable loss.

In other scenarios, the discharged device 108 might have placed itself in a suspended, hibernating, or other low-power/power-saving state in response to having detected the approaching discharge of its battery. In some of these scenarios, the device might be configured to maintain power on volatile components (such as memory) while denying power to some or all other components. As a result, it might appear to be dead although the data stored thereon can be retrieved once power returns. Moreover, some such discharged devices 108 are configured to allow brief periods of (perhaps) limited functionality should the user so desire. That is with some discharged devices 108, turning the power on will awaken the discharged device 108 sufficiently to attend to some limited activities prior to the device returning to its sleep/hibernating state. Nevertheless, a user 102 encountering a discharged device often initially notes that the discharged device 108 displays an inactive or darkened display 114 much to their possible chagrin. And even if the device can respond in some fashion to user requests, its responses are likely to be limited in functionality and certainly limited in duration (i.e., eventually its battery dies).

In contrast, a charged device 110 can exhibit a live display 116 and in many scenarios can perform many functions as illustrated by FIG. 1. For instance, the charged device 110 can capture, display, transmit, and receive, etc. video images 118. It can also, or in the alternative, record, play, transmit, receive, etc. audio files 120. Likewise, the charged device 110 of the current embodiment can handle instant messages 122 and/or email messages 124. Of course, charged devices 110 of various embodiments can be configured to handle many combinations of functions which are too numerous for practicable enumeration here.

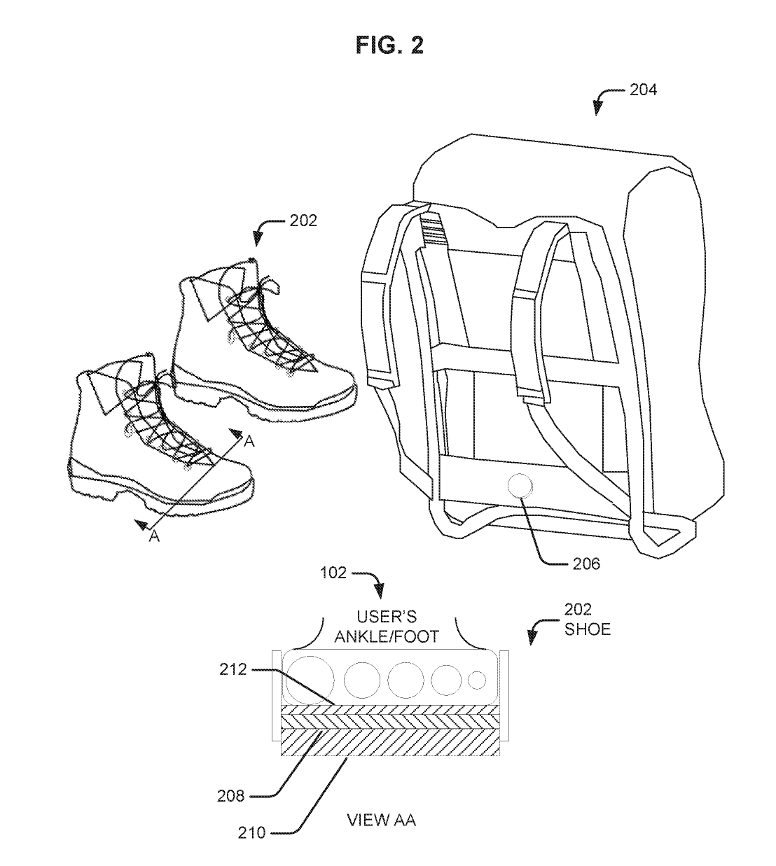

Of course, to perform these functions, these devices use power. And to that end, and/or perhaps others, embodiments provide chargers 126 which harvest energy from every day activities. FIG. 1, illustrates a charger 126 placed between a user 102 and the user's backpack or some padding in the backpack, on the charger, etc. In this position, it can be expected that the backpack will ride on and bounce against the user's back. That relative movement can be used to actuate the charger 126 thereby harvesting energy. the FIG. 1 also illustrates a charger 126 placed on a bicycle pedal such that as the user 102 pushes the pedal down (and allows it to return), the charger 126 is actuated thereby harvesting energy from this repetitive action. Of course, chargers 126 could be placed in numerous locations in the remote location 104 illustrated by FIG. 1. Some of which are further disclosed with reference to FIG. 2.

FIG. 2 illustrates various energy harvesting devices such as one incorporated into a boot 202 and one incorporated into or otherwise placed on a backpack 204. As noted with regard to FIG. 1, the charger 208 can be mounted on the frame of a backpack 204 at a location where it will harvest energy from the relative, repetitive motion between the backpack 204 and its user.

The charger 206 can likewise be positioned to harvest energy from repetitive motion between other objects. For instance, in another scenario, FIG. 2 illustrates the charger 206 being placed between the user 102 and the sole 210 (or insole 212) of the boot 202. Thus, as the user 102 places their weight on their foot it compresses the charger 206, and, as the user 102 lifts their foot it releases the pressure on the charger 206. These actions actuate the charger 206 and cause it to harvest energy from these actions. Of course, a user need not supply the motive force to actuate these chargers 206 and/or 208. Rather inanimate objects which move relative to each other in a repetitive manner could be used to actuate chargers 206 and/or 208 of embodiments.

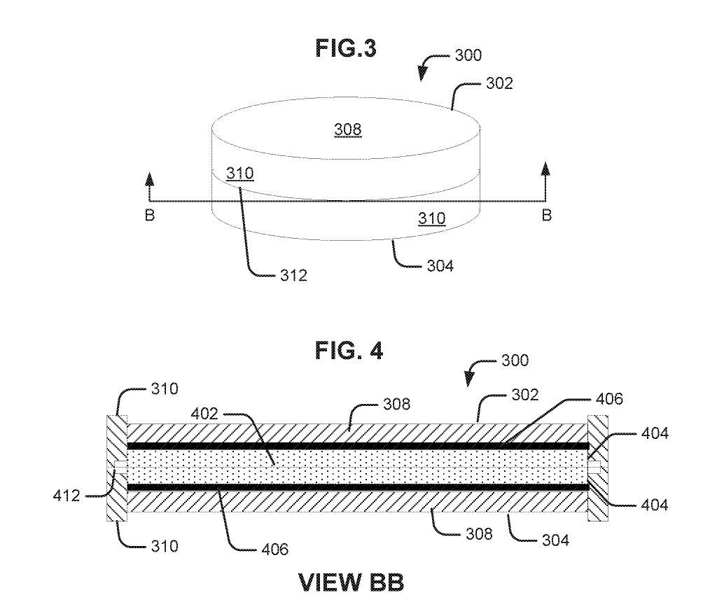

FIG. 3 illustrates an energy harvesting device of embodiments. The charger 300 illustrated by FIG. 3 includes a first enclosure 302, a second enclosure 304, internal conductors, and an insulator (which can also serve as a seal) which is positioned between the two enclosures. The enclosures 302 and 304 of embodiments contain and protect internal components (disclosed further herein) of the charger 300 while allowing external compressive forces to be transmitted thereto. Meanwhile the flexible panels skins, membranes, diaphragms, etc. 308 (on either end) of the charger 300 can be relatively flexible and the sides 310 can possess sufficient strength to protect those internal components. In some embodiments the sides 310 are made from PVC (Polyvinyl Chloride) and the panels 308 of the enclosures are made from VHB 4905, 4910, and/or 4911 tape. Furthermore, the insulator and/or seal or sealant of some type (for instance, a silicone-based sealant) insulates certain internal, charged components from the enclosures and/or each other (and can prevent fluids from leaking into and/or out/of the charger 300).

FIG. 4 illustrates a cross-sectional view of the energy harvesting device of FIG. 3 as seen along line AA. More specifically, FIG. 4 illustrates a variable capacitor 400 of a charger 300. The variable capacitor 400 of the current embodiment is housed in a pair of enclosures 302 and 304 with the sides 310 thereof protecting the internal components thereof while the resilient panels 308 enclose these internal components while also allowing actuating forces to be applied thereto. Note that in some embodiments the sides 310 can possess degrees of rigidity, flexibility, resilience, etc. desired for particular applications. D, if desired, the two enclosures 302 and 304 could be a single enclosure.

Furthermore, a resilient/compliant dielectric layer 402 is sandwiched between two resilient conductive layers 404. Some aspects of flexible dielectrics being used as generators are discussed in Dielectric Elastomers: Generator Mode Fundamentals and Applications by R. Pelrine et al., Proceedings of SPIE, vol. 4329, no. 0277-786, pp 148-155, 2001. A pair of flexible electrodes 406 contact the conductive layers 404 to place charges/voltages there and to drain the same off. The dielectric layer 402, conductive layers 404, and/or electrodes 406 can be positioned across the width and/or top/bottom of the enclosures 302 and 304. Insulating seals 412 positioned along the circumference of the enclosures 302 and 304 can seal the variable capacitor 400 and/or charger 300. The insulating seals can also serve to prevent the conductive layers 404 from contacting each other and (when charged) neutralizing the charge and associated energy.

Of course, while terms like top, bottom, across, width, etc. are used herein for convenience, they should not be interpreted as requiring that the chargers, variable capacitors, etc. disclosed herein be constructed, oriented, operated, etc. in any particular orientation, Indeed, they can be operated in most if not all orientations.

As disclosed elsewhere herein the dielectric layer 402, conductive layers 404, and electrodes are made of resilient materials. These layers, moreover, can be mechanically bonded to one another and to the panels 308. Although in many embodiments they are configured to remain in contact with (and or to conform to) one another without being mechanically bonded to one another. Thus, as a force or reciprocating driver of some sort presses (or pulls) on one of the panels 308, the layers respond by stretching, deforming, bowing in one direction or another, etc. Thus, the panels 308 actuate the variable capacitor such that the area and/or thickness of one or more of the dielectric layer 402 (and/or conductive layers 404) can change. As that force is release, reversed, counteracted by another force, etc., the layers tend to return to/toward the positions, states, areas, thicknesses, etc. which they possessed prior to the application of the force. Of course, since the layers form a capacitor, the variation of the areas and thickness of the dielectric layer 402 cause the capacitance of the capacitor to vary accordingly. If the actuating force repeats, reciprocates, etc., that capacitance will vary in a correspondingly repetitive and/or reciprocating manner thereby allowing the variable capacitor of the current embodiment to be used in a charger 300 for various devices, batteries, other energy storage devices, and/or other loads.

Note again that the panels 308 can be manufactured from resilient materials. And, in that regard, the VHB 4905 and VHB 4910 tape (coincidentally used for the dielectric layer of embodiments) can be used to form the panels 308. In some embodiments nylon is used to form the panels due at least in part to its combination of mechanical strength and resiliency.

The charger 300 of the current embodiment can be configured initially such that the dielectric layer 402 is in a pre-stretched state with a correspondingly thinned thickness (as compared to its non-stretched state). An initial bias voltage can be applied across it (via the electrodes 406) to place an initial charge on the charger 300. It has been found that such a bias voltage level can be determined by multiplying the dielectric's dielectric strength (measured in volts per unit thickness or otherwise) and the dielectric layer's thickness (in its pre-stretched state). But other bias voltage levels are within the scope of the disclosure although embodiments use the aforementioned bias voltage as a maximum bias voltage. The dielectric layer can then be stretched further by a mechanical actuating force thereby causing more thinning of the layer.

After the bias voltage and additional stretching is applied, the dielectric later 402 can be allowed to relax (with the actuating force no longer present) while the elasticity of the layers tending to act to return them to their contracted, pre-stretched state with the electrical forces tending to act to maintain it in its stretched state. The relaxation of the dielectric layer 402 causes the voltage across the dielectric layer 402 to increase (as its capacitance dereases) thereby allowing power to be drawn off, drained from, harvested, from, scavenged from, gathered from, and/or generated by the charger 300. This result occurs because as the dielectric layer relaxes, the like charges on each conductive layer 404 are brought into greater proximity (concentration) and the dislike charges on the two opposed conductive layers 404 move further apart. Those consequences cause the voltage across the dielectric layer to increase above the bias voltage allowing energy to be drawn off the charger.

Note also that the materials and/or geometry of the layers can be chosen to provide a desired range of variable capacitance and/or other electrical/mechanical characteristics as desired. More specifically, elastomeric dielectrics can be formed from at least two types of materials: those which are acrylic in nature and those that are silicone in nature. Typical silicone dielectrics tend to produce more power (on a per pound or gram basis) than typical acrylic dielectrics. But, dielectric layers 402 formed from either of or both types (as well as others) are within the scope of the current disclosure.

More particularly, in some embodiments, the dielectric layer 402 is formed from VHB 4905 or VHB4910 double-sided, electroactive polymer (EAP) tape, available from the 3M Company of St. Paul, Minn. This particular tape comes in at least two thicknesses and in some embodiments the thinner (0.5 mm) VHB4905 tape was used so as to lower the bias (and maximum) voltages occurring in the chargers. Of course dielectric layers 402 of various thickness are within the scope of the current disclosure. The pre-stretch can also be selected so as to further reduce operating voltages. For instance, in some embodiments, a 0.5 mm thick, VHB 4905 tape was pre-stretched by 200%. The thicker VHB4910 tape was also used in chargers of embodiments and was found to be in some ways relatively easy to work with due to its increased thickness and attendant ability to resist tears and/or other damage.

Of course, a factor that can be used in selecting a dielectric material is its frequency response as it pertains to the material's Maxwell strength, expansion coefficient λ, and dielectric strength. Since most human footsteps occur at a rate near 1 Hz, dielectric materials with desirable characteristics near this frequency can be selected and the aforementioned VHB 4905 tape applies well in this regard. 3M's VHB 4910 tape also works in this regard as well as with regard to its mechanical properties.

In one prototype a circular piece of the VHB 4905 electroactive polymer about 6 inches in diameter and 2 inches thick was used to generate 2.89 nJ of energy thereby validating energy harvesting in accordance with embodiments. Other prototypes are under development with dielectric layers of less than half an inch in diameter that might snap back more quickly than the 2 inch prototype. Also, (considering ergonomic aspects of a shoe-based energy harvester), a thinner dielectric layer could require less conducive gel and be more efficient at converting mechanical/kinetic energy to electrical energy. Note that some practicable considerations that can be considered in designing shoe-based energy harvesters is the amount of arch support needed/desired, the available volume in typical shoes, and the amount of additional weight/mass that users would accept on/in their shoes. Similar considerations can be applied to other non-shoe-based energy harvester designs.

The inventors have also varied the amount of pre-stretch on the (6 inch diameter) dielectric layer from between about 2 and 3 inches. And have noted that with increased pre-stretch, the dielectric layer becomes less elastic and more controllable. Indeed, given the typical 4 inch stroke of a human foot between its initial contact with the ground and its final push off during a step, these levels of pre-stretch do not expose the dielectric layer to undue risk of mechanical failure (in tension). The inventors have varied the (initial) bias voltage across the dielectric layer, the stroke of the stretch during a “step”, and the frequency of the steps (which are considerations that can be applied in designing chargers of embodiments).

With ongoing reference to FIG. 4, the conductive layers 404 can be made from a conductive gel/liquid material such as Redux® Electrolyte Paste available from Parker Laboratories of Fairfield, N.J. In the alternative or in addition, CW7100 CircuitWorks® silver conductive grease (available from Chemtronics of Kennesaw, Ga.) can be used as the conductive material. In various embodiments, the conductive layers can be formed from a conductive gel such as that used in ultrasound applications although many other conductive liquids, gels, etc. (for instance salt water) can be used. A reason that conductive gel works well in many embodiments is that it is viscous enough to remain in contact with the dielectric layer during most (if not all) movements while being relatively easy to contain in the housing. Of course, other materials can be used to fabricate the conductive layers. For instance, graphite powder has been used in chargers of embodiments. Indeed, graphite can be used where less precise covering of the dielectric layer and/or less predictability of the (variable) capacitance of the chargers can be tolerated. Salt water was also used as the conductive layer although seals and other containment features were used therewith. Note that when corrosive materials are used as the conductive material components (for instance, electrodes) that come in contact with it can be made from corrosion resistant materials. Of course, other conductive materials such as conductive liquids or materials that are at least partially liquid (for instance, oils, greases, gels, etc.)

It has also been found that the most force which occurs during a step occurs at the heel of the user. That force creates a compression of a typical shoe-heel of between 2-4 mm. Thus, to avoid noticeable ergonomic affects, embodiments are provided with chargers mimicking this 2-4 mm compression/displacement. And, of course, these chargers can be configured to be placed at or near the heel of the user in typical footwear. These chargers can be configure to produce several milliJoule of energy each. On that note one prototype charger using a bias voltage of only 40 V developed 4 microJoules of energy per cycle thereby providing further validation. Indeed variable capacitors of some embodiments have produced up to 0.8 mJ of energy.

It is envisioned that a step-up amplifier will be used in chargers of various embodiments to transform the voltage supplied by typically available batteries to voltage levels that will result in more efficient operations. For instance, one range for the bias voltage is on the order of 1200-1300 V although other bias voltage levels are within the scope of the current disclosure. In addition or in the alternative, signal conditioning circuitry and/or step-down transformers can be included in chargers of embodiments to provide the drained-off energy to a battery at an appropriate voltage level (and without unwanted voltage spikes, noise, etc.). Voltage and/or limiters and appropriate insulating materials can of course be included in these chargers as desired. For instance, chargers of some embodiments can be encapsulated within an insulating gel to contain the electrical energy present therein.

In other embodiments though the chargers operate at lower voltages. While chargers of such embodiments might operate at somewhat reduced efficiency they might also be somewhat easier to design and/or manufacture. For instance, as voltage levels decrease, more commercially available components, materials, etc. are available for use with these chargers. Also, the cost, size, weight, etc. of such components/materials decreases with decreasing voltage. Accordingly, users may select chargers based on their voltage levels, cost, size, weight, etc. depending on the circumstances under which they wish to use the chargers.

Of course, chargers 300 of some embodiments can be configured to power other devices such as GPS units, cameras, computers, etc. Indeed, the inventors have ascertained that an 80 kg person generates approximately 2.4 J/step (or roughly 67 watts) which with a full day of walking (roughly 10,000 steps) can equate to approximately 70% of the charge stored by many such devices.

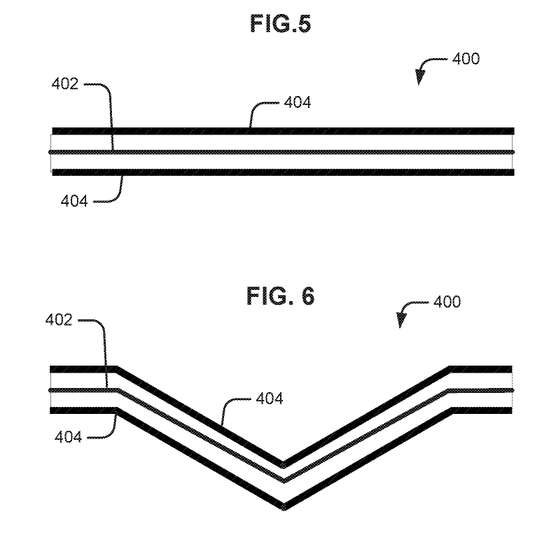

FIG. 5 and FIG. 6 illustrate a variable capacitor 400 of an energy harvesting device in a pre-stretched state and in a stretched state respectively. Note that the dielectric layer 402 (and/or conductive layers 404) can be pre-stretched by application of a tensile force acting across the layer in a manner somewhat similar to stretching an acoustic drum head with tensioning rods. Other methods of pre-stretching the tape are within the scope of the disclosure. For instance, a biaxial film stretching machine can be used to pre-stretch the dielectric while it is held in place. It is noted at this juncture that a typical cycle of chargers of embodiments operate through four phases: stretch, charge, active, and discharge. In the stretch phase, the dielectric layer 402 is stretched thereby increasing its capacitance. In the charge phase, the bias voltage is supplied/restored thereby (inputting energy into the charger 300 and) readying the charger 300 of the current embodiment to harvest mechanical energy. The dielectric layer 402 then relaxes during the active phase (to a point of equilibrium between the mechanical and electrical forces acting on it) thereby reducing its capacitance and increasing the electrical energy stored therein. This action has the effect of amplifying the input energy and/or generating electrical energy from the mechanical forces involved in the stretching of the dielectric layer 402. In the discharge phase all (or some) of the charge is removed or drained from the charger 300) while it is freed of mechanical stresses and while it thereafter returns to its pre-stretched dimensions.

Of course, there will be some energy losses during such cycles. Some will be lost to the environment. There will also be some energy lost during the electromechanical energy conversion process. Still more energy might be lost in the scavenging circuits. Thus, a battery or other power source can be provided to supply a makeup charge for the next cycle. That make up charge supplies the initial electrical energy for the next cycle which then gets amplified using the harvested mechanical energy (thereby producing additional storable/usable energy).

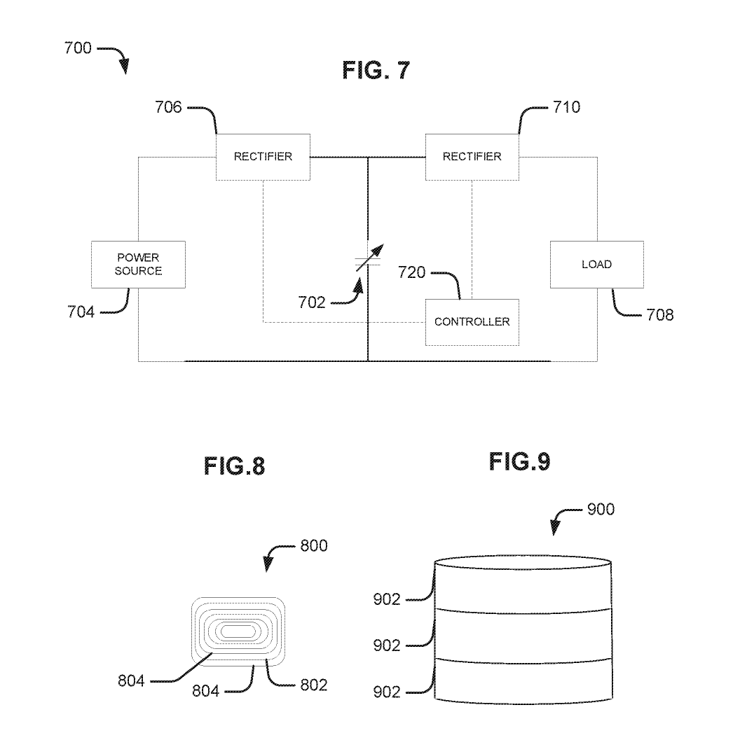

FIG. 7 illustrates a block diagram of an energy harvesting device. More specifically, FIG. 7 illustrates a circuit 700 associated with an energy harvesting device of embodiments. The circuit 700 comprises a variable capacitor 702, a power supply 704, a rectifier 706, a load 708, another rectifier 710, and a controller 720. The variable capacitor 702 of the current embodiment is actuated by a repetitive and/or reciprocating force and as such its capacitance varies in accordance with the variation of the actuating force.

Moreover, the power supply 704 can be a battery, an active power source such as an AC (alternating current) or DC (direct current) generator, or any other source capable of placing at least an initial charge on the variable capacitor 702. It is in electrical communication with the rectifier 706 and the variable capacitor 702 as illustrated. The rectifier 706 can be any type of device capable of allowing current flow in only the direction from the power supply 704 toward the variable capacitor 702. For instance, it could be a diode, a half wave rectifier, a full wave rectifier, etc. and it could include filtering, output smoothing, etc. capabilities. In some embodiments, switches are used in place of (or in combination) with the rectifying device and which are actively controlled by the controller 720 which can be any type of controller (such as an embedded circuit and/or processor). Moreover, the controller 720 could sense the state of the variable capacitor 702 and activate the switches accordingly to block/allow current to flow there through. In some embodiments, for instance, the controller could sense voltages, currents, battery levels etc. and regulate the duty cycle of the variable capacitor/charger using the switches. In these and/or perhaps other ways, power is allowed to flow to/from the variable capacitor in accordance with the switch settings.

With continuing reference to FIG. 7, the other rectifier 710 can be similar to the rectifier 708 although it could be a different type of rectifying device. Moreover, it is in electrical communication with the variable capacitor 702 and the load 708 as also illustrated by FIG. 7. As to the load 708, it can be a mobile device, a mobile device battery, a stand-alone battery, a battery in recharger, or any other device that could use power as supplied by the circuit 700.

In operation, the circuit 700 works as follows. For illustrative purposes, it can be assumed that the variable capacitor 702 is in a pre-stretched state. The power supply 704 supplies an initial charge which flows, from it, through the rectifier 706 and thence to the variable capacitor 702. In the current scenario, a mechanical actuating force stretches the variable capacitor 702 thereby varying the area and/or thickness of its dielectric, and causing the voltage across it to increase. As a result, at least temporarily, a voltage difference exists between the variable capacitor 702 and the load 708. However, the rectifier 710 allows current to flow from the variable capacitor 702 to the load 708 as urged by that voltage difference. Thus, the circuit 700 delivers energy/power to the load 708.

Thus, some energy has been harvested from the actuating force via the variable capacitor 702 and delivered to the load 708. The force actuating the variable capacitor 702 then reverses, the variable capacitor 702 relaxes and returns to its pre-stretched state. Thus, the operations of a single charger 300 of embodiments has been disclosed. In addition, or in the alternative to single charger 300 devices of embodiments, multiple chargers can be used together to create devices of greater capacity as shown in FIG. 9.

FIG. 8 illustrates another single-charger energy harvesting device that perhaps has greater capacity than at least some other single-charger devices. More specifically, FIG. 8 illustrates an embodiment in which the charger 800 resembles a rolled capacitor. For the sake of convenience, the charger 800 is shown in FIG. 8 in cross section with the rolled dielectric and conductive layers 802 and 804 visible. The rolled charger 800 of the current embodiment can be advantageously employed where relatively small form factors and/or relatively high energy harvesting densities are desired.

FIG. 9 illustrates another energy harvesting device. But this energy harvesting device has multiple chargers and, perhaps, therefore greater capacity than single-devices. In the current embodiment, a stacked charger 900 includes several individual chargers 902 which are stacked one atop another and mechanically coupled together. In this way, when a (compressive) force is applied to (or removed from) the stack, each charger is stretched and harvests energy from the object producing the force. Moreover, because these stacked chargers 902 can be wired in series or parallel (or combinations thereof) with one another, users can select whether the stacked charger 900 generates either a higher voltage or higher current across the device in accordance with the wiring scheme.

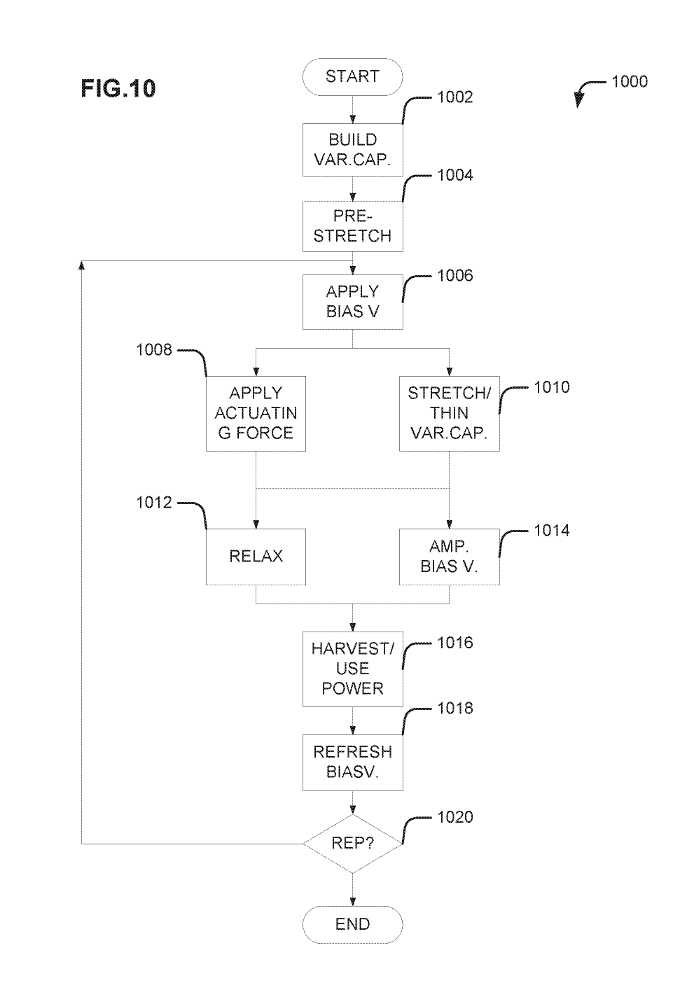

FIG. 10 illustrates a flowchart of a method. In accordance with embodiments, the illustrated method 1000 includes various operations such as building a variable capacitor and/or a charger. That variable capacitor can be a rolled capacitor, one of many in a stacked variable capacitor, and/or a can be a single-capacitor to be used in or as a charger of embodiments. See reference 1002. Moreover, the variable capacitor can be pre-stretched thereby thinning the dielectric later as indicated at Ref. 1004. A bias voltage can be applied to the variable capacitor to prepare the variable capacitor/charger for a (or the next) cycle (see reference 1006).

Method 1000 continues at operations 1008 and 1010 during which an actuating force is applied to the variable capacitor and stretches/thins it accordingly. Of course, the stretching of the dielectric layer (and conductive layers) imparts mechanical energy to the variable capacitor that while these materials are stretched is stored therein as potential energy. That potential energy is released as the mechanical actuating force disappears, reverses, or is otherwise removed from the variable capacitor. See reference 1012.

That relaxation, as disclosed elsewhere herein, moves the dislike charges on/in the conductive layers further apart (because the dielectric layer expands/becomes thicker) while also bringing the like charges on/in the conductive layers into closer proximity to one another (because the conductive layers move to a less stretched state). Both actions therefore move charges against the electric filed(s) present in the variable capacitor. And, of course, as an electric charge moves against an electric field energy, the electric potential energy of the charge (associated with the pertinent electric field) increases. The net effect of the thinning is, therefore, to amplify the voltage across the variable capacitor and the amount of energy stored therein as indicated at reference 1014. Thus, some of the mechanical energy imparted to the variable capacitor is converted to available/potential electrical energy.

With ongoing reference to FIG. 10, reference 1016 shows that the potential electrical energy (as represented by the amplified across the variable capacitor) can be harvested and/or drawn off. The harvested energy, moreover, can be transferred to a battery or other storage device or used in some other type of load (for instance, a mobile device). See reference 1016. Of course, as the energy is harvested, the voltage across the variable capacitor will likely decrease. If desired, the bias voltage across the variable capacitor can be refreshed to its original level or some other desired level (see reference 1018). Indeed, method 1000 can be repeated (in whole or in part) or terminated as indicated at reference 1020.

Tables 1 and 2 (below) shows the results of a series of experiments in which the Inventors built and tested various prototype chargers. More particularly, variable capacitors 2″ in diameter in accordance with embodiments were built using VHB 4910 tape as the dielectric layers and CW 7100 silver grease as the conductive layers. Braided copper wick was also used in the variable capacitor as the electrodes. The wick's fabric-like structure seemed to help prevent tears in the variable capacitor. It was stretched through 4″ of displacement with a wooden dowel cover in Lycra® (available from Investa of Wichita, Kans.) before it ripped. The Lycra fabric was chosen at least in part because of its relatively high ductility and ability to resist adhering to the VHB 4910 dielectric layers. And as noted previously, the results of testing with 2″ of displacement are shown in Tables 1 and 2. Where:
V_{bias} is the initial bias voltage applied to the variable capacitor(s);
V_{bias}, actual is the bias voltage as measured at the variable capacitor;
Q(C) is our calculated charge on the variable capacitor plates given V_{bias};
V_{gen} is the ideal output voltage that was calculated;
V_{gen}, actual is the actual output voltage;
Vₛₚᵢₖₑ, actual is the difference between the V_{genb}, actual and V_{bias}, actual and is a measure of how much the bias voltage was amplified and hence how much energy was harvested;
I_{gen}, actual is the “actual” current generated by the variable capacitor and was obtained by dividing V_{gen}, actual by the 10 kohm resistance of a resistor placed in parallel with the variable capacitor;
Igen, actual C_{max(A)} is the calculated output current when the variable capacitor was at its maximum capacitance;
Igen, actual C_{min(A)} is the calculated output current when the variable capacitor was at its minimum capacitance;
Peak time (s) is the length of time that the variable capacitor was generating energy; and
V_{con} is the control voltage that sets V_{bias}.

TABLE 1
Experimental Results

| | | Vbias, | | | Vgen, |
|---|---|---|---|---|---|
| Vcont | Vbias | actual | | Vgen | actual |
| (V) | (V) | (V) | Q (C) | (V) | (V) |
| 0.1 | 50 | 40 | 3.97767E−07 | 135.0221744 | 48 |
| 0.5 | 250 | 208 | 1.98884E−06 | 675.1108722 | 224 |
| 1.13 | 565 | 500 | 4.49477E−06 | 1525.750571 | 540 |
| 2.4 | 665 | 1000 | 5.29031E−06 | 1795.79492 | 1120 |
| 3.4 | 765 | 1500 | 6.08584E−06 | 2065.839269 | 1680 |
| 4 | 2000 | 1800 | 1.59107E−05 | 5400.886978 | 2060 |

| | Vspike, | Igen, | Igen, | Igen, | Peak |
|---|---|---|---|---|---|
| Vcont | actual | actual | actual, | actual, | time |
| (V) | (V) | (A) | Cmax (A) | Cmin (A) | (s) |
| 0.1 | 8 | | | | |
| 0.5 | 16 | 0.0224 | #DIV/0! | #DIV/0! | |
| 1.13 | 40 | 0.054 | 2.55E−06 | 8.87E−07 | 0.11 |
| 2.4 | 120 | 0.112 | 9.33E−06 | 3.25E−06 | 0.09 |
| 3.4 | 180 | 0.168 | 1.33E−05 | 4.62E−06 | 0.095 |
| 4 | 260 | 0.206 | 2.80E−05 | 9.76E−06 | 0.065 |

TABLE 2
Further Experimental Results

| | | Expected | Measured | |
|---|---|---|---|---|
| Vbias | Vgen, expected | Energy (J) | Energy (J) | Error % |
| 490 | 1405.737705 | 0.001570490164 | 0.0005433 | 65.40570502 |
| 985 | 2825.819672 | 0.00634622582 | 0.001581 | 75.08755527 |
| 1480 | 4245.901639 | 0.01432737049 | 0.003939 | 72.5071673 |
| 1760 | 5049.180328 | 0.02026135082 | 0.005983 | 70.47087308 |

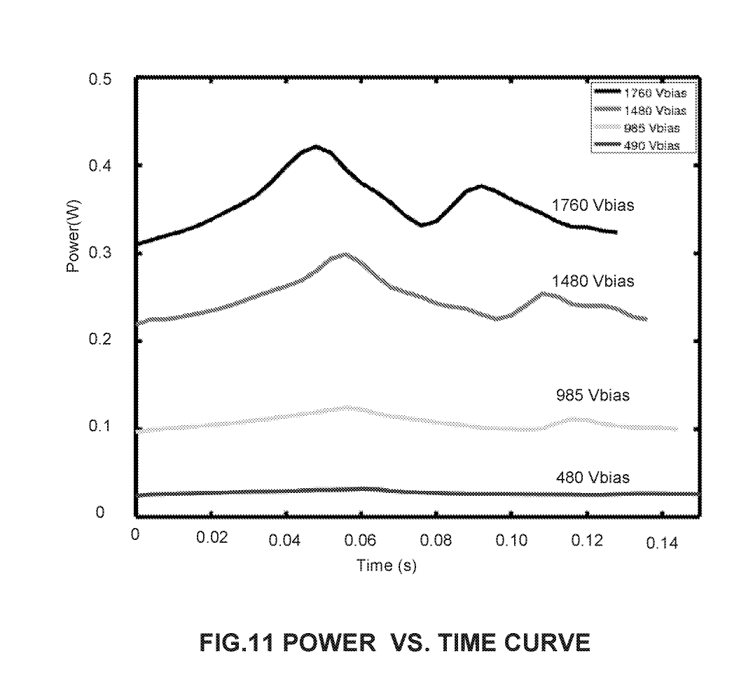

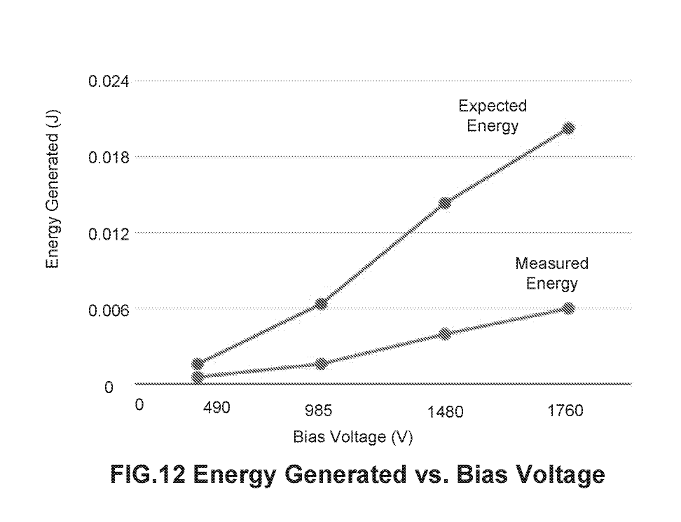

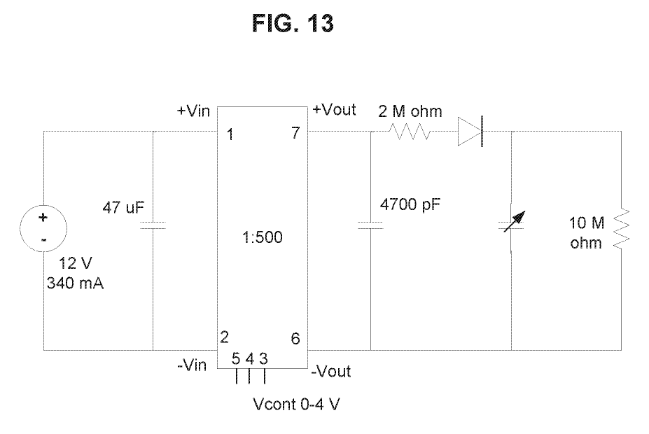

FIG. 11 is a graph illustrating the power verse time performance of an experimental variable capacitor. FIG. 12, in contrast illustrates a graph of the expected energy and actual energy generated by that experimental variable capacitor. FIG. 13 illustrates a schematic of an energy harvesting device of embodiments.

Further planned tests include improving the experimental variable capacitors by providing improved means for retaining the silver grease on the dielectric layer, using electrodes with less resistance, etc. Notably, experiments with more efficient DC/DC converters (which stepped up the input voltage to the bias voltage) are also planned since the converter used in the experiments consumed between 50% and 60% of the energy generated by the variable capacitor thereby leading to the errors noted in Table. Indeed without these losses even the experimental variable capacitor would likely have been experience errors on the order of only 5% to 10%. And errors at such low levels do provide validation that chargers of embodiments will generate sufficient energy to re-charge/power various devices.

Furthermore, 3M VHB 4905, 4910, 4950, and 4611 tapes can be used as the flexible dielectric in chargers of various embodiments. Silicone-based tapes such as NuSil CF20-2186 tape (available from NuSil Technology LLC of Carpintaria, Calif.) are also within the scope of the current disclosure. These dielectric materials were considered based on various combinations of the following properties: piezoelectric charge constant, piezoelectric voltage constant, dielectric permittivity dielectric constant, elastic compliance, Young's Modulus, electrochemical coupling factor, and dielectric dissipation factor. Other factors that were considered were the ability of the dielectric materials to resist creep, their fatigue strength, their ability to retain elasticity with repeated cycling, their ability to resist tearing and/or maintain the separation of the conductive layers, their ability to resist tearing, etc.

Various conductive materials were considered for use in chargers of the current embodiment. Conductive gels are attractive candidates because of their ability to maintain contact with the conductors of the chargers and their ability to follow the movement of the flexible dielectrics. Conductive liquids were also considered but the gels were found to be easier to contain/seal. Water (salt water) and lemon juice were also considered and are within the scope of the disclosure. As to the gels, aloe vera and salt-based gels were considered as well as Spectra 360 gel and CW7100 silver grease and other conductive, partially liquid materials. Commercially available copper tape was used for the electrodes of chargers of embodiments to place the conductive layers in electrical communication with external devices and/or support circuitry. In various embodiments, braided solder wick was used to form the electrodes and was found to be relatively easy to work with due to its softness, ductility, etc.

As to the overall mechanical design of the chargers of the current embodiment, factors considered included their overall shape, surface area, and dielectric thickness. At least three types of chargers are provided herein: 1) parallel plate chargers, 2) rolled, parallel plate chargers, and 3) stacked plate chargers. Thus energy harvesting systems, apparatus, and methods have been provided. In many embodiments, the energy harvesters are configured to harvest energy from human movements. For instance, some embodiments provide energy harvesters configured to fit within a shoe and, more particularly, the insole of a shoe. The shoes can be open-toed (for instance, sandals) or closed-toed shoes. Moreover, energy harvesters of embodiments can harvest energy over multi-day excursions/periods when a user might be remote from heretofore available energy sources (such as wall outlets).

The energy harvested can be distributed by any manner such as by providing a USB (Universal Serial Bus) connector on the energy harvesters although connectors of other configurations are within the scope of the disclosure. For instance, energy harvesters can be adapted to charge AA, AAA, C, D, lithium-ion, lithium-polymer, and other types of batteries and/or battery charged devices. Note also that in some embodiments, a battery is located near and connected to the energy harvester. For instance, a battery can be (removably) attached to the outside of a shoe with a connector placing it in electrical communication with the energy harvester so that the harvested energy can be stored in the battery.

Moreover, energy harvesters of embodiments can be relatively light and reliable compared to electromagnetic (coils/transformers) and other piezoelectric-based alternatives. More specifically, energy harvesters of embodiments avoid brittle-fracture problems associated with many crystalline piezoelectric materials and avoid the weight associated with using coils, transformers, inductors, etc. the like to harvest mechanical energy from users. Indeed, many of the materials used in chargers of embodiments have densities on the order of 1 g/cm³. And it is here noted that users of such energy harvesters might experience discomfort because of the weight of typical coil-based devices. Moreover, the comparative simplicity of energy harvesters of embodiments might lead to correspondingly low manufacturing (and hence retail) costs when compared to piezoelectric and coil-based devices. Embodiments, moreover, provide energy harvesters capable of being worn all day while accumulating charge without the user (wearer) noticing the harvester.

### CONCLUSION

Although the subject matter has been disclosed in language specific to structural features and/or methodological acts, it is to be understood that the subject matter defined in the appended claims is not necessarily limited to the specific features or acts disclosed above. Rather, the specific features and acts described herein are disclosed as illustrative implementations of the claims.

1. An energy harvesting apparatus for generating off-grid power for mobile devices, the apparatus comprising:
a variable capacitor;
a battery in electrical communication with the variable capacitor and being configured to place the initial charge on the variable capacitor;
an actuator operably coupled to the variable capacitor and configured to be driven by a reciprocating driver to be external to the apparatus wherein as the driver to reciprocate the actuator to vary the capacitance of the variable capacitor wherein as the capacitance of the variable capacitor to vary the capacitance of the variable capacitor to deliver power to the battery;
wherein the variable capacitor further comprises a dielectric formed from an insulating membrane; and
wherein the variable capacitor further comprises a pair of conductive layers and wherein at least one of the conductive layers further comprises a an electrically conductive material which is at least partially liquid.

2. An energy harvesting apparatus comprising:
a variable capacitor;
a source of at least an initial charge in electrical communication with the variable capacitor and being configured to place the initial charge on the variable capacitor;
an actuator operably coupled to the variable capacitor and configured to be driven by a reciprocating driver to be external to the apparatus wherein as the driver to reciprocate the actuator to vary the capacitance of the variable capacitor; and
a load in electrical communication with the variable capacitor wherein as the capacitance of the variable capacitor to vary the variable capacitor to deliver power to the load.

3. The apparatus of claim 2 wherein the load is a battery.

4. The apparatus of claim 3 wherein the battery is the source of the initial charge.

5. The apparatus of claim 2 wherein the variable capacitor further comprises a plurality of stacked variable capacitors.

6. The apparatus of claim 2 wherein the variable capacitor further comprises a dielectric formed from an insulating membrane.

7. The apparatus of claim 2 wherein the insulating membrane is pre-tensioned.

8. The apparatus of claim 2 wherein the variable capacitor further comprises a pair of conductive layers and wherein at least one of the conductive layers further comprises a material selected from a group consisting gels, greases, and oils.

9. The apparatus of claim 2 wherein the variable capacitor further comprises a dielectric layer and the actuator is further operably coupled to the variable capacitor in such a manner that it varies a thickness of the dielectric layer.

10. The apparatus of claim 2 wherein the variable capacitor further comprises a dielectric layer and the actuator is further operably coupled to the variable capacitor in such a manner that it varies an area of the dielectric layer.

11. The apparatus of claim 2 wherein the variable capacitor further comprises a dielectric layer and at least a portion of one surface of the dielectric layer is coated with a release agent.

12. An energy harvesting system comprising:
a variable capacitor;
a source of at least an initial charge in electrical communication with the variable capacitor and being configured to place the initial charge on the variable capacitor;
an actuator operably coupled to the variable capacitor;
a reciprocating driver operably coupled to the actuator and configured to drive the actuator wherein as the driver to reciprocate the actuator to vary the capacitance of the variable capacitor; and
a load in electrical communication with the variable capacitor wherein as the capacitance of the variable capacitor to vary the variable capacitor to deliver power to the load.

13. The system of claim 12 wherein the load is a battery.

14. The system of claim 13 wherein the battery is the source of the initial charge.

15. The system of claim 12 wherein the variable capacitor further comprises a plurality of stacked variable capacitors.

16. The system of claim 12 wherein the variable capacitor further comprises a dielectric formed from an insulating membrane.

17. The system of claim 12 wherein the insulating membrane is pre-tensioned.

18. The system of claim 12 wherein the variable capacitor further comprises a pair of conductive layers and wherein at least one of the conductive layers further comprises a material selected from a group consisting of gels, greases, and oils.

19. The system of claim 12 wherein the variable capacitor further comprises a dielectric layer and the actuator is further operably coupled to the variable capacitor in such a manner that it varies a thickness of the dielectric layer.

20. The system of claim 12 wherein the variable capacitor further comprises a dielectric layer and the actuator is further operably coupled to the variable capacitor in such a manner that it varies an area of the dielectric layer.
